(19) United States
(12) Patent Application Publication
(10) Pub. No.: US 2004/0042038 A1
(43) Pub. Date: Mar. 4, 2004

(54) Image forming system and back-end processor

(75) Inventor: Hiroyoshi Uejo, Kanagawa (JP)

Correspondence Address: OLIFF & BERRIDGE, PLC, P.O. BOX 19928, ALEXANDRIA, VA, 22320, US

(73) Assignee: Fuji Xerox Co., Ltd., Tokyo (JP)

(21) Appl. No.: 10/388,812

(22) Filed: Mar. 17, 2003

(30) Foreign Application Priority Data
Aug. 29, 2002 (JP) 2002-250332

(51) Int. Cl. G06F 3/12; H04N 1/40; G06F 13/00; G06F 15/00

(52) U.S. Cl. 358/1.15; 358/2.1

(57) ABSTRACT

A printing controller 620 for controlling an engine 30 in accordance with the processing characteristics of the engine 30 is removed from the FEP 500, so that the FEP 500 can exclusively perform the RIP processing or compressive processing. The printing controller 620 removed from the FEP 500 is relocated in a BEP 600 closely related to the output side. An image storage portion 602 for storing data received from the FEP 500 is provided in the BEP 600. This allows the FEP 500 to perform processing independent of the printing engine 30 on the output side. For example, it is possible to perform efficient RIP processing or compressive processing using a general-purpose RIP engine. Since the BEP 600 is responsible for the control in processing suitable for devices on the output side, it is not necessary to provide each of the devices on the output side with a dedicated FEP, thereby making it easy to improve the performance and function of the system.

### BACKGROUND OF THE INVENTION

The present invention relates to an image forming system that comprises an image forming apparatus having a so-called printing function for forming images on a recording medium such as color copiers, facsimiles, or printers and a back-end processor that constitutes the image forming system.

An image forming apparatus having printing function such as printers or copiers are employed in various fields. In recent years, those image forming apparatuses are provided with color printing capabilities and thereby employed to meet user requirements for various expressions. For example, color page printers employing the electro-photography process (xerography) receive widespread attention focused on their high-quality images and high-speed printing.

On the other hand, from the viewpoint of the printing function, those image forming apparatuses are largely divided into two types: one, such as for personal use at home or business use in an office, requiring a relatively small-scale printout capability (e.g., several to several tens of sheets of paper per one job) and the printing industry in bookbinding, etc., requiring a relatively large-scale printout capability (e.g., several thousands of sheets of paper per one job). Most of the former apparatuses (e.g., except the screen printing), of which required is a relatively small-scale printout capability, receive print data to deliver printouts without creating any artwork. On the other hand, the latter, of which required is a relatively large-scale printout capability, creates artwork in accordance with print data to deliver printouts using the artwork created.

However, in recent years, the printing process is changed due to the widespread use of DTP (Desk Top Publishing/Prepress) or the so-called “digital innovation in printing.” That is, attention is focused on “direct printing” by which printing is performed directly from DTP data or “on-demand printing.” This on-demand printing employs a CTP (Computer to Print or Paper) scheme for delivering printouts in accordance with electronic data by completely digitizing the pre-press step without creating any intermediate products in conventional printing (e.g., offset printing), for example, printed photographic paper such as by phototypography, artwork, halftone negative, halftone positive, or PS print. Thus, a printing function employing the electro-photography process receives attention for the requirements of on-demand printing.

FIG. 7 is a schematic view illustrating a prior art image forming system. FIG. 7A is a view illustrating the entire configuration of the system, FIG. 7B being a view illustrating a data flow.

As shown in FIG. 7A, the image forming system comprises an image forming apparatus 1, and a DFE (Digital Front End Processor) or a terminal device that passes print data to the image forming apparatus 1 and directs printing thereto.

The image forming apparatus 1 makes use of the electro-photography process to record images on a predetermined recording medium, comprising an IOT (Image Output Terminal) module 2, a feed (paper feed) module (FM=Feeder Module) 5, an output module 7, a user interface 8, and a coupling module 9 for coupling the IOT module 2 to the feed module 5.

The DFE comprises a drawing function and a printer controller function. The DFE receives sequential print data described such as in PDL (Page Description Language) from a client terminal device (not shown), and then converts the print data into raster image (RIP processing process=Raster Image Process) Subsequently, the DFE sends the image data processed through RIP processing and print control information (job ticket), such as the number of prints and the size of the paper, to the image forming apparatus 1. The DFE thus controls the printing engine of the image forming apparatus 1 or the paper feed system so that the image forming apparatus 1 performs printing. That is, the printing operation of the image forming apparatus 1 is controlled by means of the printer controller of the DFE.

The image forming apparatus 1 receives, as print data, fundamental colors for color printing, that is, yellow (Y), cyan (C), magenta (M), and black (K) (herein after referred to as “YMCK” for short).

The user interface 8 supports easy-to-understand dialogues between the operator and the image forming apparatus 1. To provide improved operability, the user interface 8 comprises a color display 8a incorporating a touch panel and a hard control panel 8b arranged beside it, which are supported on support arms 8c on a base machine (the main body or the coupling module 9 in this example) as shown in the figure.

The IOT module 2 has an IOT core portion 20 and a toner supplier 22. The toner supplier 22 is adapted to incorporate toner cartridges 24 for use with YMCK for color printing.

The IOT core portion 20 comprises printing engines (printing unit) 30 each having an optical scanner 31 and a photosensitive drum 32 for each of the aforementioned color components. The printing engines 30 are configured in tandem with each other or arrayed in a row in the belt rotational direction. The IOT core portion 20 comprises an electric control system housing 39 for housing an electric circuit for controlling the printing engine 30 or a power supply circuit for use with each module.

To transfer images, the IOT core portion 20 transfers a toner image on the photosensitive drum 32 onto an intermediate transfer belt 43 by means of a primary transfer device 35 (primary transfer). Thereafter, a secondary transfer portion 45 transfers the toner image on the intermediate transfer belt 43 onto a print sheet (Secondary transfer). With this arrangement, each color toner of YMCK is used to form the image on each of the photosensitive drums 32, the toner image being then transferred in multiple onto the intermediate transfer belt 43.

The image transferred onto the intermediate transfer belt 43 (the toner image) is transferred onto a sheet fed from the feed module 5 at predetermined time intervals. The sheet is then transported to a fuser 70 along a second transport path 48, where the toner image is melted and fused on the sheet by the fuser 70. Thereafter, the sheet is temporarily held in an exit tray (stacker) 74 or intermediately passed to a sheet releaser 72, being allowed to exit the system after completing processing if necessary. For two-sided printing, a printed sheet is extracted from the exit tray 74 to an inversion path 76, being passed to an inversion transport path 49 of the IOT module 2.

As described above, after having received print data described in the Page Description Language (PDL) from the client terminal device, the DFE on the input side interprets the PDL to create image data of each page, which is in turn sent to the image forming apparatus 1 on the output side. In general, rendering is performed on the entire image data for each one output (typically one page) before outputting the image. The IOT module 2 on the output side and the output module 7 perform printing operation (image forming operation) synchronous to the printing engine 30 and the fuser 70 in accordance with the image data received in page units under the control of the front end processor.

On the other hand, in recent years, there are growing demands for higher performance and higher speeds in image formation processing (printing). To meet these demands for higher performance and higher speeds, an image forming apparatus is suggested which incorporates a high-speed and high-performance CPU. The image forming apparatus enables high-speed control by making use of the speed of the printing engine and supports total productivity ranging from printing directions to print output for high-speed color printing, e.g., 100 to 200 sheets/minute or more.

On the other hand, to operate such a high-speed and high-performance image forming apparatus, it is necessary not only to improve the image forming apparatus but also to provide a high-speed and high-performance printer controller which serves as a printing controller for controlling RIP processing and the image recorder on the output side.

However, a DFE having the conventional front-end processor function cannot be coupled to the image forming apparatus to meet the aforementioned demands. For example, the prior art DFE is adapted to perform not only RIP processing on the PDL data received from a client terminal device but also additional processing such as page rearrangement according to printing jobs (such as sorting in ascending or descending order, determination of the order of pages for two-sided printing, and relocation for finishers) or data conversion according to the processing characteristics of the printing engine and the fuser on the output side (such as calibration of gray balance or color shift).

It is therefore necessary to generate image data (or video data) processed through RIP processing in accordance with the characteristics of the image forming apparatus, perform high-level processing in accordance with the characteristics of the printing unit, or provide sync control to the driver. This made the DFE and the image forming apparatus substantially inseparable from each other. Electric signals are transmitted between the DFE and the image forming apparatus 1 through dedicated connection interfaces using a dedicated communications protocol.

However, since the DFE and the image forming apparatus 1 are inseparably related to each other as described above, the higher the speed of the image forming apparatus, the heavier the loads for generating image data processed through RIP processing in accordance with the characteristics of the image forming apparatus and for providing control to the output side. This makes it difficult to provide higher speed processing capability to the DFE.

On the other hand, raster data for one output (e.g., an entire page) is very large. For example, the color page printer employing the electro-photography scheme requires raster data corresponding to the four toners of YMCK and is also required for higher image quality than those of monochrome page printers. Thus, it is a common practice for color data to have a plurality of information bits for one pixel, for example, several to several hundreds of megabytes per page. This causes the DFE to transfer a large amount of raster data to the output side devices, thereby increasing transfer loads.

As shown in FIG. 7B, to reduce the amount of data, RIP processing-processed raster data is once compressed and then sent to the output side (the IOT module 2 in the previous example), expanded on the output side synchronous to the printing speed of the image recorder (the IOT core portion 20 in the previous example), and then passes the raster data to the image recorder (e.g., see the Unexamined Japanese Patent Application Publication No. Hei8-6238). This eliminates the problems of the transfer load and realizes the “RIP While RUN” processing scheme in which printing is carried out in the image recorder while rasterizing is being performed through RIP processing, thereby making full use of the high-speed engine to provide high productivity. These types of controls are carried out in jobs or in page units under the control of the printer controller.

However, this scheme has a combination of RIP, compression, and expansion processing, thus requiring synchronization among them. That is, it is necessary to develop the Page Description Language to the raster data and then expand it while compressing it in the course of compression and transfer to the output device. As a result, the speed of RIP processing needs to follow that of the printing engine. That is, it is necessary for the RIP processing, compression, and expansion to be carried out synchronous to one another in page units and jobs.

For this reason, in the conventional scheme employing the combination of RIP processing, compression procesing, and expansion processing, the input side has originally no need to perform RIP processing synchronous to the printing engine if adapted only to perform the basic function or for delivering of printouts. However, the input side is revised to perform these types of processing synchronous to the printing engine or to follow the speed dependent on the printing engine. Thus, while using a general-purpose RIP engine, DFEs are independent of one another, thereby raising problems of an increase in man-hours for development of DFEs and creating a need for users to purchase DFEs according to their types.

Additionally, an image forming apparatus (image forming system) with improved operating speeds would cause the DFE to bear the burden of performing the RIP processing, compression processing, and expansion processing in parallel, thereby raising a problem of being incapable of operating at higher speeds.

For example, such a system is being suggested which has a RIP engine equipped with a high-speed and high-performance CPU to provide color prints of 100 to 200 sheets per minute or more. However, systems having the conventional configuration will bear the burden of RIP processing, compression processing, and expansion processing in parallel, thereby making it impossible to make full use of the potential capabilities thereof.

### SUMMARY OF THE INVENTION

The present invention is developed in view of the aforementioned problems. It is therefore a first object to provide an image forming system that is capable of flexibly expanding the performance and improving the speed of the system.

Furthermore, it is a second object of the present invention to provide a back-end processor that constitutes the image forming system capable of flexibly expanding the performance and improving the speed of the system.

That is, a first image forming system according to the present invention comprises a front-end processor having an image data generator for generating image data of each page by processing a printing job, and a back-end processor for receiving image data of each page from the front-end processor, sending the image data to an image recorder, and controlling the image recorder. First, the front-end processor generates the image data independent of the image recorder.

Furthermore, the first image forming system according to the present invention is provided with a back-end processor that comprises an image storage portion for receiving and storing image data processed by the front-end processor independent of the image recorder, and a printing controller for providing control to perform processing dependent on the image recorder on the image data read from the image storage portion and then send the image data to the image recorder.

The processing dependent on the image recorder may be image processing performed on the image data itself or predetermined processing performed on each portion of the apparatus to obtain a desired output image. In the former case, the printing controller provides control so as to transmit processed image data to the image recorder.

A second image forming system according to the present invention comprises a front-end processor having an image data generator for generating image data of each page by processing a printing job, a compressive processor for compressing image data generated by the image data generator, and a back-end processor comprising an expansive processor, provided corresponding to an image recorder for recording an image on a predetermined recording medium, for expanding compressed image data of each page from the front-end processor and then sending the expanded image data to the image recorder, wherein the front-end processor generates and compresses the image data asynchronous to a processing speed of the image recorder.

Furthermore, the second image forming system according to the present invention is provided with a back-end processor that comprises an image storage portion for receiving and storing compressed image data processed by the front-end processor asynchronous to the processing speed of the image recorder. In addition, the expansive processor reads the compressed image data from the image storage portion and then performs expansive processing synchronous to the processing speed of the image recorder. The back-end processors ends the processed image data obtained by performing expansive processing separately to the image recorder.

In the foregoing, the image recorder is a generic name for functional portions related to the image forming operation on the job instructed by a client. The typical functional portions contained in the image recorder include a printing engine, fuser, transport member for transporting recording media, or finisher.

Furthermore, in the foregoing, the “processing independent of the image recorder” means not necessarily perfectly independent of the image recorder or the back-end processor for controlling the image recorder. It also means that image data is generated to a certain extent in freedom generally independent thereof without being strongly restricted by data (generally independent of the processing speed of the image recorder).

In the present invention, the processing characteristics or the processing speed of the image recorder may be related at least to one of these functional portions. In particular, the present invention can be effectively applied to the printing engine employing the electro-photography process in relation to the printing engine or the fuser.

The back-end processor according to the present invention is a back-end processor (mainly consisting of the printing control function) suitable for constituting the aforementioned first and second image forming system, comprising the functional portions described in the aforementioned system.

The inventions set forth in the subordinate claims specify more advantageous implementation examples for the image forming system or the back-end processor according to the present invention.

In the image forming system configured as described above, the front-end processor has an image data generation function but no printer controller function for providing control dependent on the output side. The printer controller function for providing control dependent on the output side is provided on the back-end processor. The front-end processor sends the generated image data to the back-end processor independent of the output side. The back-end processor receives the image data sent from the front-end processor and then stores it temporarily in the image storage portion. Then, the back-end processors ends image data to the image recorder in sequence in accordance with the processing characteristics of the output side, and controls the image recorder for printing.

For example, this allows the front-end processor and the image recorder to perform asynchronous processing, and the back-end processor and the image recorder to perform synchronous processing, the difference therebetween being cancelled out by storing data in and reading the data out of the image storage portion. When image data is compressed or expanded, the compressive processing of the front-end processor and the expansive processing of the back-end processor or the operation of the image recorder can be performed asynchronously. This makes it possible for the front-end processor to operate without being dependent on the operations of the back-end processor or the image recorder.

### BRIEF DESCRIPTION OF THE DRAWINGS

FIGS. 1A and 1B are views illustrating an embodiment of an image forming system according to the present invention;

FIG. 2 is a block diagram illustrating a first embodiment of a front-end processor FEP and a back-end processor BEP;

FIGS. 3A to 3C are explanatory views illustrating the difference between a prior art image forming system and an image forming system to which the first embodiment is applied;

FIG. 4 is a block diagram illustrating a second embodiment of a front-end processor FEP and a back-end processor BEP;

FIGS. 5A to 5D are explanatory views illustrating the separation of line work data DLW and continuous tone image data DCT;

FIG. 6 is a block diagram illustrating a third embodiment of a front-end processor FEP and a back-end processor BEP; and

FIGS. 7A and 7B are schematic perspective views illustrating a prior art image forming system.

### DETAILED DESCRIPTION OF THE PREFERRED EMBODIMENTS

Now, the present invention will be explained below with reference to the accompanying drawings in accordance with the embodiments.

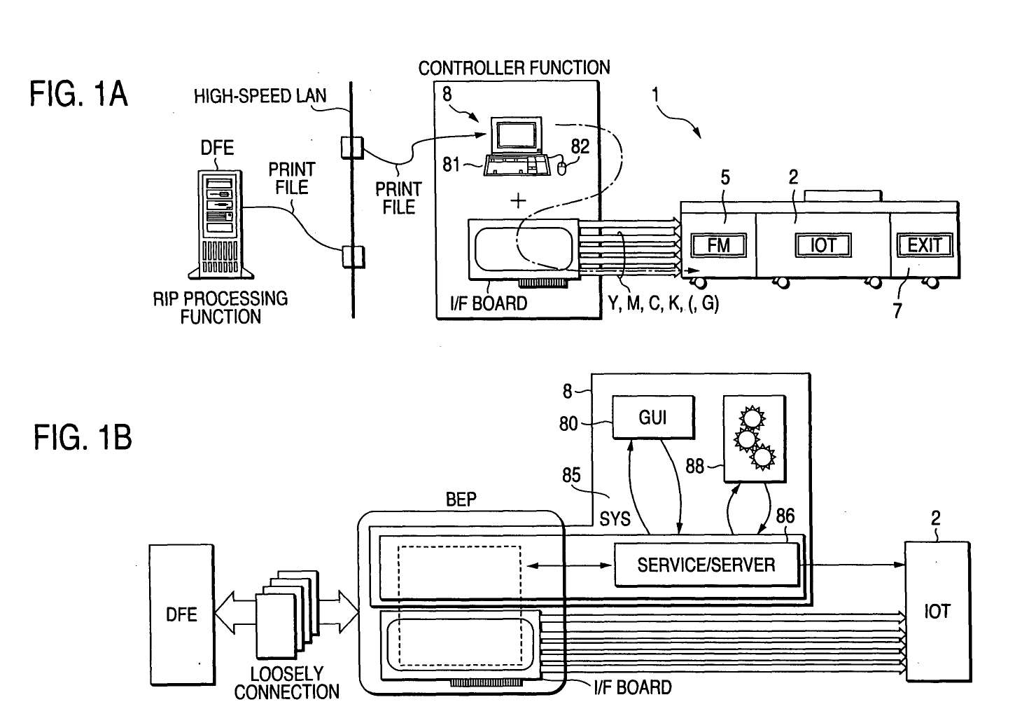

FIG. 1 is a view illustrating an image forming system according to an embodiment of the present invention. FIG. 1A is a schematic perspective view illustrating the configuration of the system, FIG. 1B showing an example of the system connected to a detailed user interface.

This image forming system comprises an image forming apparatus 1 and a DFE or a terminal apparatus that supplies print data to the image forming apparatus 1, thereby providing an instruction thereto to carry out printing.

As described in the prior art section, the image forming apparatus 1 is intended to utilize the electro-photography process to record images on a predetermined recording medium. The image forming apparatus 1 is adapted to function as a printer that forms visible images on the predetermined recording medium in accordance with the print data supplied from a client terminal device.

That is, the image forming apparatus 1 in the image forming system comprises the IOT module (IOT main body) 2, the feeder module (FM) 5 for feeding sheets of paper, the output module 7, and a user interface 8 such as a personal computer (PC). The feed module 5 may be constructed in multiple stages. There may also be provided coupling modules for coupling between the modules if necessary.

Furthermore, there may be provided a finisher module at the stage subsequent to the output module 7. For example, the finisher module can be equipped with a stapler for stacking sheets of paper and binding them at their corners or at two or more portions of their side, or with a punching mechanism to punch holes used for filing. Preferably, the finisher module can be used in an off-line condition when disconnected from the user interface 8.

The image forming apparatus 1 serves as an image recorder according to the present invention. The internal configuration of the image forming apparatus 1 is generally the same as that of the prior art described above, and thus will not be repeatedly explained.

The DFE comprises a front-end processor FEP. Like the DFE shown in the prior art, the front-end processor FEP allows a front engine to perform ROP (Raster Operation), thereby converting data received from a client into raster data (through RIP processing) and then compressing the converted raster image. The RIP processing and compression processing are performed at high speeds so as to respond to the high-speed processing performed by the IOT module 2. On the other hand, the front-end processor FEP of the DFE has no printer controller function for performing printing control depending on the image forming apparatus 1, and is different from the DFE according to the prior art in performing only RIP processing in principle.

The user interface 8 has input devices such as a keyboard 81 and a mouse 82, a GUI (Graphic User Interface) portion 80 for receiving entered instructions while presenting images to the user. In its main body (not shown), the user interface 8 also comprises a system controller Sys 85 serving as a server and the connection interface between each of the modules of the image forming apparatus 1 and the DFE. Furthermore, the user interface 8 has a printer controller function for performing printing control depending on the image forming apparatus 1.

With this arrangement, the portion of the printer controller function for providing control of the processing depending on the image forming apparatus 1 of the user interface 8 and the portion related to the connection interface are called BEP (Back-End Processor). Consequently, the user interface 8 configured according to this embodiment is adapted to include the GUI portion 80 and the printer controller function portion for providing control in accordance with the engine characteristics such as the IOT core portion 20.

The DFE allows the front engine to perform RIP processing on the code data generated by the client to create raster data and compresses the resulting data. Electric signals are transmitted between the front-end processor FEP on the DFE side and the back-end processor BEP on the side of the image forming apparatus 1 relatively loosely with respect to the IOT core portion 20. That is, the user interface 8 is constructed with a communications interface (loose connection with a general-purpose network) independent of the printing engine 30 serving as the image recorder.

For example, as shown in FIG. 1A, the DFE and the back-end processor BEP may be connected to each other with a high-speed wired LAN (Local Area Network) in accordance with a general purpose communications protocol at 1 GBPS (Gigabit per Sec) of communications speed. For example, print files are transferred in the form of files from the front-end processor FEP to the back-end processor BEP according to FTP (File Transfer Protocol).

In contrast to this, electric signals are transmitted between the back-end processor BEP and the IOT core portion 20 constituting the image recorder (or the main portion thereof) relatively closely with respect to the IOT core portion 20. That is, the user interface 8 is constructed with a communications interface dependent on the printing engine 30 serving as the image recorder. For example, the connection is established by means of a dedicated communications protocol.

The user interface 8 incorporates control software for controlling the image forming apparatus 1, and is connected to a DFE comprising an image process system IPS. For example, the user interface 8 receives, from the DFE, print data processed through RIP processing (Raster Image Process) and printing control information relating to the number of printed sheets of paper and the size of the paper, allowing the image forming apparatus 1 to perform printing processing requested.

Print data includes fundamental colors for color printing, or three colors of yellow (Y), cyan (C), and magenta (M), and black (K), four colors (YMCK) in total. In addition to these four colors, a fifth color component, for example, gray (G) may be included.

The back-end processor BEP providing the printer controller function receives printing control information (a printing command) in conjunction with image data from the DFE via an interface portion in the image forming apparatus 1, providing a control function for printing (or processing dependent on engine characteristics) depending on the image forming apparatus 1. Furthermore, for example, the back-end processor BEP enables efficient high-speed output by utilizing the data received from the DFE and held in the image forming apparatus 1 for the purposes of outputting multiple sheets in a collation mode and reprinting for an additional printout after completion of the initial printing.

For this reason, the back-end processor BEP is provided with a controller for generating command codes in accordance with the printing control information received from the DFE to control the processing timing of each portion of the image forming apparatus 1 according to the engine characteristics. Additionally, the back-end processor BEP completes spooling so as to meet the engine characteristics such as the IOT module 2, the feed module 5, and the output module 7, and then passes image data to the IOT module 2. The back-end processor BEP provides control processing depending on the engine characteristics.

Furthermore, the back-end processor BEP automatically recovers clogged sheets of paper depending on the engine characteristics. The system also allows the front-end processor FEP to determine directions from a client, causing the front-end processor FEP to perform processing if possible for only the front-end processor FEP independent of each portion of the image forming apparatus 1 such as the IOT core portion 20, the fuser 70, and the finisher portion. Likewise, the front-end processor FEP is commanded to pass therethrough to the back-end processor BEP side such processing that is dependent on each portion of the image forming apparatus 1 and that should be carried out by the BEP processor.

For example, the DFE sends print file data including raster-based images processed by RIP processing to the back-end processor BEP. The print file data includes raster-based image file data, e.g., in the form of TIFF (Tagged Image File Format) as well as printing control information such as the number of printouts, two-sided or one-sided printing, color/monochrome printing, combined printing, execution of sorting, or a requirement for stapling.

For example, the front-end processor FEP performs processing such as rotation, page allocation in one sheet of paper (N-UP), repeating, matching of paper sizes, correcting for differences among devices by CMS (Color Management System), resolution conversion, contrast adjustment, and specifying compression ratios (low/medium/high), without their control commands being notified to the back-end processor BEP (non-notification).

On the other hand, the types of processing strongly related to the processing characteristics of the image forming apparatus 1 (those dependent on the IOT) are positioning processing such as collation and two-sided printing, related to the finisher (e.g., a stamp, punch, and stapler) or the sheet tray: calibration processing such as adjustment of paper exit face (top or bottom) and correction of gray balance and color shift; and screen designation. The control commands of those types of processing are passed through the front-end processor FEP and thus processed by the back-end processor BEP.

Paper sizes may be adjusted not only by means of the front-end processor FEP but also the back-end processor BEP.

As described above, with the configuration according to this embodiment, image data is transferred in files as compressed data such as TIFF data toward the user interface 8, for example, by FTP (File Transfer Protocol). That is, the front-end processor FEP transfers jobs toward the back-end processor BEP one-sidedly in the order in which each job is subjected to RIP processing independent of the engine characteristics, and then the back-end processor BEP performs page reallocation for printing.

According to the configuration of this embodiment, the DFE is freed from complicated processing based on the engine characteristics, thereby making it possible for an ordinary PC (personal computer) to be employed as the DFE with software installed in the PC and thus provide the functions of the front-end processor FEP.

Additionally, the back-end processor BEP responsible for complicated processing based on the engine characteristics is freed from the RIP processing, thereby making it possible to flexibly change data conversion methods or printing control in accordance with the performance of the IOT module 2.

This makes it possible to readily provide the printer controller to the engine or the desired target required on business even when the front-end processor FEP does not have particular information on the engine characteristics and know-how.

That is, the back-end processor BEP can receive, from the front-end processor FEP, image data for forming images and image forming conditions (such as the number of copies, one-sided/two-sided printing, colors, sorting execution), and then provide control to the image forming operation of the associated apparatus in accordance with the engine characteristics. Unlike the conventional DFE, the back-end processor BEP is not limited in use of the standard controllers. This makes the control of the image forming operation by the back-end processor BEP more flexible in terms of speeds and expandability than that provided by the DFE. Accordingly, it is easy to provide the image forming apparatus 1 with improved speeds and functions.

The front-end processor FEP of the DFE can perform RIP processing and compression processing and the back-end processor BEP can carry out page reallocation in accordance with the image forming apparatus 1, and thus the DFE and the image forming apparatus 1 can be loosely related to each other (Loose connection). That is, the DFE is limited only to RIP processing or compression processing that is not affected by the performance of the image forming apparatus 1. This reduces the processing burden of the DFE, thereby making it possible to use a DFE comprising a general-purpose controller capable of performing high-speed processing and thus reducing total system costs.

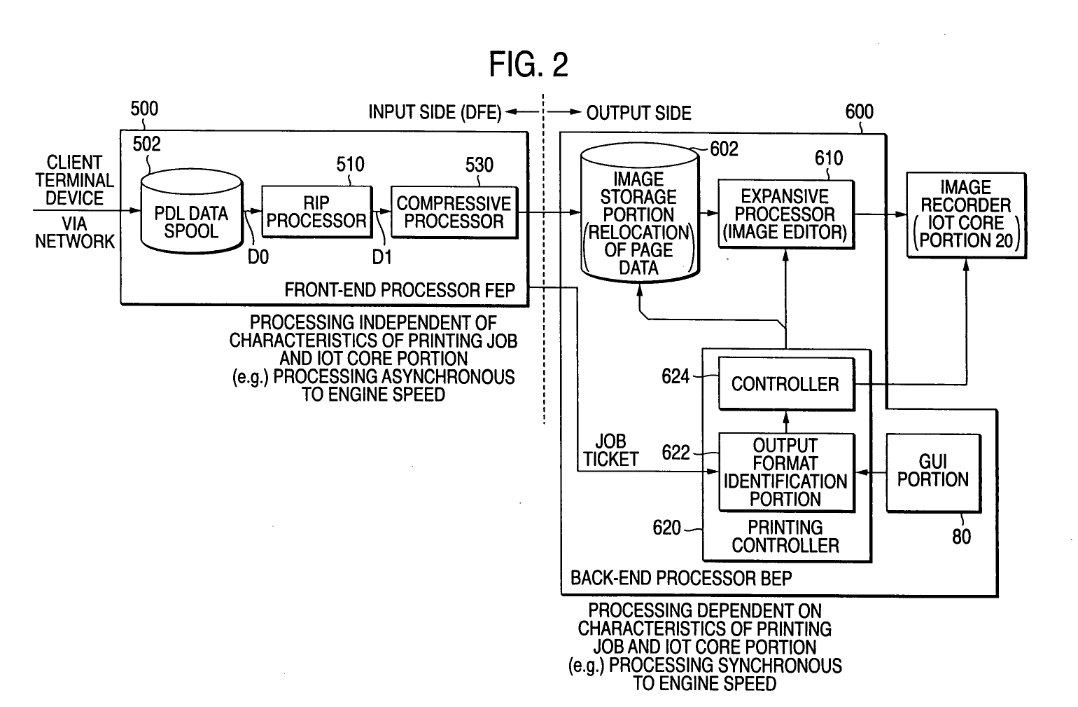

FIG. 2 is a view focused on the data flow between the DFE and the image forming apparatus 1, being a block diagram illustrating a first embodiment of a front-end processor FEP 500 and a back-end processor BEP 600.

The front-end processor FEP 500 comprises a data storage portion 502 for receiving print data described in PDL (hereinafter referred to as the PDL data) from a client terminal device (not shown) connected thereto via a network and then temporarily storing the PDL data, a RIP processor (raster image processor) 510 for reading and interpreting the PDL data from the data storage portion 502 to generate (rasterize) image data (raster data) in page units, and a compressive processor 530 for compressing the image data generated at the RIP processor 510 in a predetermined format.

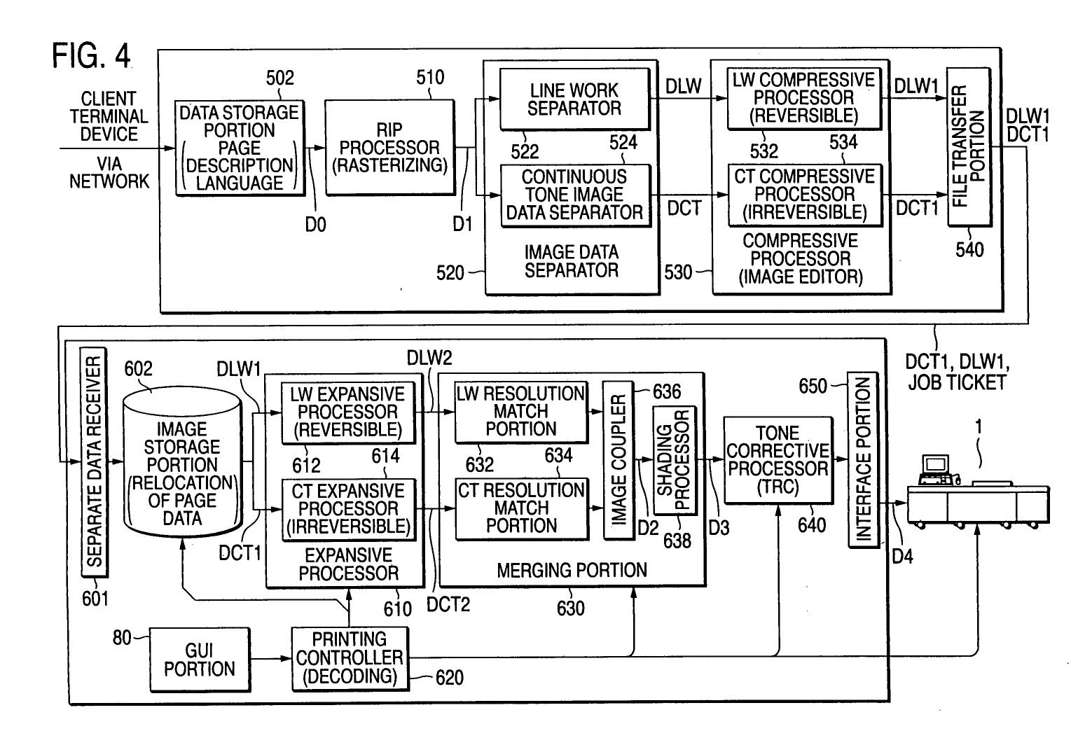

Although not illustrated, at the stage subsequent to the compressive processor 530, there is provided a communications interface, independent of the image recorder, for transmitting electric signals between the output side such as the IOT module 2 or the output module 7 and the back-end processor BEP 600 (see FIG. 4).

The RIP processor 510, an example of an image data generator, develops electronic data described in Page Description Language (PDL) to generate image data. For this purpose, the RIP processor 510 incorporates a decomposer serving as a PDL interpreter and an imager or the so-called RIP engine. As described later, the RIP processor 510 may be equipped with a dedicated RIP engine corresponding to the printing engine peculiar to this embodiment or with a general-purpose printing RIP engine. Alternatively, the entire front-end processor FEP 500 may be a RIP processing apparatus (DFE apparatus) provided by other manufacturers.

The compressive processor 530 compresses image data from the RIP processor 510 and then intermediately transfers the compressed image data to the back-end processor BEP 600. The front-end processor FEP 500 provides no change to a job ticket unnecessary for itself and indicative of the printing job contents received in conjunction therewith, intermediately transferring the job ticket to the back-end processor BEP 600 at predetermined timing.

The front-end processor FEP performs processing asynchronous to the speed of processing of the printing engine 30. That is, the front-end processor FEP 500 receives PDL data from a client terminal device, then performs raster and compression processing in sequence on the PDL data, and intermediately after that, sends the compressed image data to the back-end processor BEP 600. In the course of this process, when the reception of the PDL data from the client terminal device occurs earlier than the raster and compression processing, the front-end processor FEP 500 temporarily stores delayed PDL data in the data storage portion 502. Then, the PDL data is read out of the data storage portion 502 and processed in the order of reception (on a FIFO basis) or in an appropriate order (e.g., on a FILO basis).

On the other hand, the back-end processor BEP 600 comprises an image storage portion 602 for receiving and storing the compressed image data that is processed at the front-end processor FEP 500 independent of the printing job and the processing characteristics of the printing engine 30 (e.g., asynchronous to the processing speed of the printing engine 30), and an expansive processor 610 for reading the compressed image data from the image storage portion 602, performing expansive processing on the data corresponding to the compressive processing of the compressive processor 530 at the side of the front-end processor FEP 500, and sending the expanded image data towards the IOT core portion 20.

The expansive processor 610 has an image editor function for performing rotation of an image or adjustment of the position of the image on a sheet of paper or enlargement or contraction on the expanded image data read from the image storage portion 602. This functional portion responsible for this image editor function may be provided independent of the expansive processor 610.

Although not illustrated, at the stage previous to the image storage portion 602, there is provided a communications interface, independent of the image recorder, for transmitting electric signals between the output side such as the IOT module 2 or the output module 7 and the front-end processor FEP 500 (see FIG. 4). Although not illustrated, at the stage subsequent to the expansive processor 610, there is also provided a communications interface on the output side, dependent on the image recorder, for transmitting electric signals with the image recorder (see FIG. 4).

Furthermore, the back-end processor BEP 600 comprises a printing controller 620 serving as a printer controller for providing control to each portion of the back-end processor BEP 600 or the IOT core portion 20 dependent on the processing performance of the IOT core portion 20.

Although not illustrated, the printing controller 620 comprises an output format identification portion for interpreting (decoding) the job ticket supplied from the front-end processor FEP 500 or receiving user instructions via the GUI portion 80 to identify the output format (the position of an image in a page or the exit order and orientation of the pages) in accordance with the processing characteristics of the printing engine 30, the fuser 70 or the finisher, and a controller for controlling each portion of the printing engine 30, the fuser 70 or the finisher.

The back-end processor BEP 600 accumulates temporarily the image data transferred from the front-end processor FEP 500 in the image storage portion 602 that serves as a buffer. The expansive processor 610 reads and expands the compressed image data from the image storage portion 602, assembles the page data (reallocation of page data) in accordance with the printing job specified by a client terminal device or the front-end processor FEP 500, and prepares for transferring the page data to the designated printing engine.

Then, the back-end processor BEP 600 sends the page data at a speed maximizing the productivity of the engine while exchanging control commands synchronous to the processing speed of the printing engine 30.

When the front-end processor FEP 500 sends data earlier than the processing (synchronous processing) suitable for the processing characteristics of the printing engine 30 is performed, the back-end processor BEP 600 temporarily stores delayed image data or a job ticket in the image storage portion 602. The back-end processor BEP 600 then reads page data so as to match the exit conditions (orientation of the pages or execution of finishing processing) desired by the user, edits images as required, corrects the position of the image on a sheet of paper, performs image forming processing as desired by the user, and sends the processed image data to the IOT module 2.

This provides asynchronous processing between the front-end processor FEP 500 and the output side such as the printing engine 30 or the fuser 70 serving as the image recorder, and synchronous processing between the back-end processor BEP 600 and the output side, the difference therebetween being cancelled out by storing the data in and reading the data out of the image storage portion 602. Even in the case of compressing or expanding the image data, the compressive processing at the front-end processor FEP 500 and the expansive processing at the back-end processor BEP 600 are carried out synchronous to each other. That is, according to the configuration of the first embodiment, the RIP processing at the front-end processor FEP 500 or the subsequent compressive processing are performed independent of the printing job contents, the processing characteristics of the IOT core portion 20 and the fuser 70 which constitute the image recorder.

As described above, in the front-end processor FEP 500 according to the first embodiment, the image data rasterized (graphically developed) from the Page Description Language at the RIP processor 510 is transferred in the order of the pages to the back-end processor BEP 600 loosely related thereto. Up to this stage, the processing is performed according to the performance of the RIP engine, requiring no special need to depend on the processing speed (synchronous) or control of the printing engine.

To realize these types of processing, the printing controller 620 serving as the printer controller 620 interprets (decodes) the job ticket supplied by the front-end processor FEP 500 or receives user instructions via the GUI portion 80 to control each portion.

For example, the expansive processor 610 reads the compressed image data from the image storage portion 602 and performs expansive processing synchronous to the processing speed of the printing engine 30. As required, the front-end processor FEP also performs processing data (conversion of color data) dependent on the printing engine 30 and then sends the resulting data to the printing engine 30. At this time, in accordance with the printing job, the printing controller 620 sorts pages in the ascending or descending order, determines the order of pages to be printed at the time of two-sided printing, or performs page reallocation such as repositioning corresponding to the finisher (securing the positions of holes for stapling or punching). This allows printouts to be outputted in the form specified by the client irrespective of the type of the IOT core portion 20 or the finisher portion.

As described above, in the configuration according to the first embodiment, the front-end processor FEP 500 transfers image data in files as TIFF compressed data, for example, by FTP to the back-end processor BEP 600. That is, both are loosely related to each other only for file transfer, and thus the front-end processor FEP 500 transfers each job to the back-end processor BEP 600 one-sidely, in the order in which the jobs are processed through the RIP processing, independent of the engine characteristics. The back-end processor BEP 600 is responsible for those types of processing such as reallocation of pages for printing dependent on printing job or the printing engine 30.

According to the first embodiment, the front-end processor FEP 500 is freed from complicated processing based on the engine characteristics, thereby making it possible for an ordinary PC (personal computer) to be employed with software installed therein as the front-end processor FEP 500 and thus provide the functions of the front-end processor FEP 500. That is, a general-purpose front-end processor FEP 500 can be realized.

Additionally, the back-end processor BEP 600 responsible for complicated processing based on the engine characteristics is freed from the RIP processing, thereby making it possible to flexibly change processing or control in accordance with the performance of the IOT module 2, the fuser 70 or the finisher.

This makes it possible to readily provide the printer controller equipped with a general-purpose RIP engine for the engine or the desired target required on business even when the front-end processor FEP 500 does not have particular information on the engine characteristics or know-how.

Since the front-end processor FEP 500 is independent of the printing engine 30, the user can also use his newly purchased printing engine for his conventional front-end processor. Furthermore, the user can also connect the printing engine to a front-end processor supplied by other manufacturers. That is, it is possible to use a general-purpose RIP engine or a RIP engine by other makers.

For example, in the Unexamined Japanese Patent Application Publication No. Hei10-166688, a system in which a front-end processor FEP is separated from the back-end processor BEP for controlling the image recorder is suggested. However, in this system, the RIP processing is dependent on the printing job and the printing engine performance. For this reason, upon controlling the image data to be outputted to the IOT core portion 20 in a predetermined order, the back-end processor BEP issues a request for acquiring a next job to the front-end processor FEP at the time the printing processing of a printing job is completed. This request for acquiring a next job is informed to the front-end processor FEP via a network.

The front-end processor FEP performs the RIP processing on the new job in response to the acquisition request and then supplies the processed data to the back-end processor BEP. That is, although the RIP processor and the printer controller are separated from each other in terms of hardware, there is no substantial difference from the conventional one in that the RIP processing is dependent on the printing job and the performance of the printing engine 30. This is common to the implementation according to the first embodiment in that the RIP processor and the printer controller are separated from each other in terms of hardware, but totally different in dependency of the RIP processing on the printing job and the performance of the engine.

For example, in a case where re-processing related to the RIP processing is required, such as page allocation in one sheet of paper (N-UP), repeating, matching of paper sizes, correcting for differences among devices by CMS (Color Management System), resolution conversion, contrast adjustment, and specifying compression ratios (low/medium/high), the system disclosed in the Unexamined Japanese Patent Application Publication No. Hei10-166688 regenerates image data at the front-end processor FEP and then transfers the resulting data to the back-end processor. Thus, a front-end processor FEP equipped with a general-purpose RIP engine suffers from a significant burden of processing and requires a significantly long time for processing. Additionally, data needs to be retransmitted, thereby resulting in an increase in communications load.

On the other hand, in a case where required are the types of processing, dependent on the processing characteristics of the image forming apparatus 1 (e.g., the printing engine) on the output side, such as rotation of images, collation, two-sided printing, and image shift which are related to the finisher (e.g., a stamp, punch, and stapler) or the sheet tray: calibration processing such as adjustment of paper exit face (top or bottom) and correction of gray balance and color shift; and screen designation, the system disclosed in the Unexamined Japanese Patent Application Publication No. Hei10-166688 requires the front-end processor FEP to control the output side based on thorough knowledge of the engine characteristics or know-how or in some cases regenerate image data to transfer the resulting data to the back-end processor. Thus, a front-end processor FEP equipped with a general-purpose RIP engine suffers from a significant burden of processing and requires a significantly long time for processing.

In contrast to this, the configuration according to the first embodiment is divided into the front-end processor FEP 500 and the back-end processor BEP 600. In accordance with the processing characteristics of the image recorder on the output side such as the printing engine 30 and the fuser 70, the printing controller 620 for controlling the printing engine 30 on the output side is removed from the FEP 500, so that the FEP 500 can devote itself to the RIP processing or compressive processing. The printing controller 620 removed from the front-end processor FEP 500 is relocated onto the back-end processor BEP 600 that is tightly connected to the output side. Additionally, the data received from the front-end processor FEP 500 is held in the image storage portion 602.

This arrangement makes it possible to provide a system that allows the front-end processor FEP 500 to be loosely related to the output side, thereby making the processing of the front-end processor FEP 500 independent of the printing engine 30 or the output side. The difference in the course of processing is cancelled out (adjusted) by storing the data in and reading the data out of the image storage portion 602.

For example, the processing related to the RIP processing is carried out by means of the front-end processor FEP; however, when the RIP processing needs to be re-performed, reuse of the data stored in the image storage portion 602 is made without requiring the front-end processor FEP 500 to re-perform the RIP processing (independent of the front-end processor FEP 500). This eliminates the need of re-performing the RIP processing at the front-end processor FEP 500, thereby reducing the burden of the front-end processor FEP 500 by that amount. Since data does not need to be re-transmitted, transmission load is reduced and the total processing is performed faster.

Furthermore, processing dependent on processing characteristics of the output side can be performed at the back-end processor BEP 600 that has a performance adapted to the output side such as a printing engine and is closely related to the printing engine 30 or the like. For example, in a case where such processing is required that is dependent on the processing characteristics of the output side when the output is provided in the form desired by the client, irrespective of the front-end processor FEP 500 (i.e., independently), the system controls each functional portion of the back-end processor BEP 600 to perform processing according to the output format desired by the client and send image data to the output side. It is not a heavy burden to perform the processing adapted to the engine at the back-end processor BEP 600. For this reason, the configuration according to this embodiment provides improved throughput.

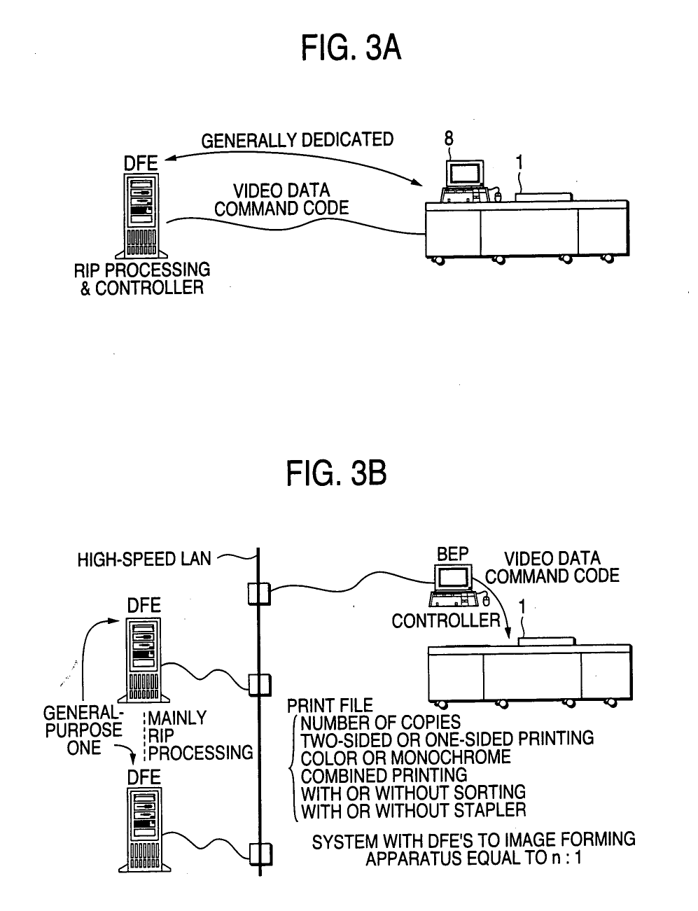

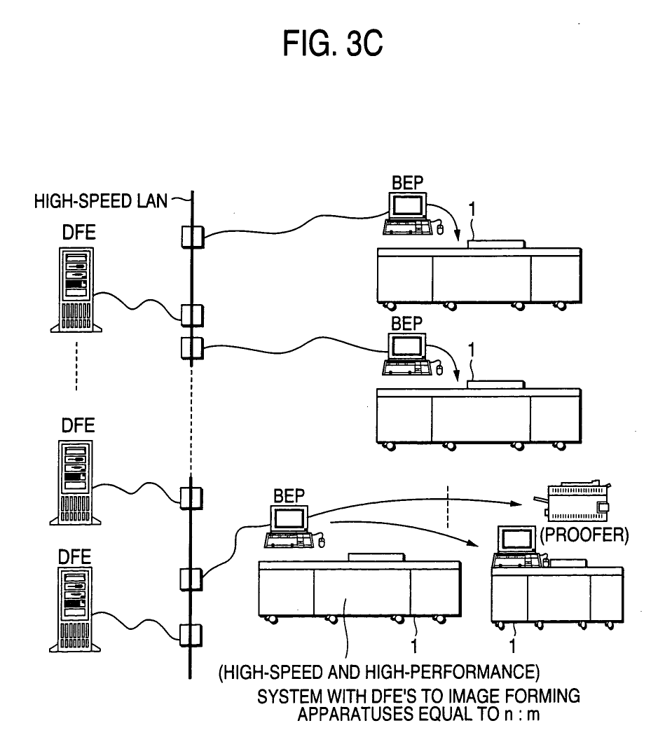

FIG. 3 is an explanatory view illustrating the difference between the prior art image forming system and the image forming system incorporating the first embodiment. FIG. 3A shows the prior art configuration, while FIGS. 3B and 3C show an exemplary system configuration according to the first embodiment.

In the example of the prior art configuration, the image data (or video data) processed through the RIP processing in accordance with the characteristics of the image forming apparatus 1 is passed from the DFE to the IOT module 2. Upon improving the speed of the image forming apparatus 1, the higher the speeds, the more difficult for the controller on the DFE to control the processing timing of each portion in the image forming apparatus 1. For this reason, as shown in FIG. 3A, the DFE and the image forming apparatus 1 are substantially inseparable, thereby resulting in such a configuration in which a dedicated DFE is used to respond to individual image forming apparatus 1.

For example, upon developing raster data (i.e., the RIP processing) or controlling a printing unit, a high-performance model of DFE employs an industry standard controller that claims high image quality and high-level control. Unless the front-end processor FEP has thorough knowledge of the engine characteristics and know-how, it is impossible to control the high-speed and highly functional image forming apparatus 1. However, the higher the speed and function, the more difficult the control becomes. Accordingly, the prior art configuration needs a DFE that performs the dedicated processing function suitable for the image forming apparatus 1. For this reason, it is difficult to construct a system in which one image forming apparatus 1 receives printing requests from a plurality of DFEs.

For example, in a case where the system is improved in function and speeds, what can be done is only to inform a standard controller in advance of a method for controlling the image forming apparatus 1, allowing the image forming apparatus 1 to operate under the control of the standard controller. However, improved speeds and function make it difficult to control the image forming operation of the image forming apparatus 1 at the improved speeds and function by means of the prior art controller or a general-purpose controller. For example, during continuous processing, it becomes more difficult to control when starting the image forming process for the next sheet (print paper). In particular, for two-sided printing, it is necessary to allow printing on the reverse surface of sheets to be carried out in the course of a continual transfer of sheets having their front-pages printed, however, it is more difficult during processing at higher speeds to control this operation.

In contrast to this, the configuration according to the first embodiment is implemented such that the DFE (more specifically, the front-end processor FEP 500) is mainly responsible for the RIP processing functional portion and the back-end processor BEP 600 is responsible for the printer controller function. This makes it possible for the back-end processor BEP 600 to receive image data for forming images and image forming conditions (such as the number of copies, one-sided/two-sided printing, colors, execution of sorting), and control the image forming operation of the associated apparatus in accordance with the performance and characteristics of the printing engine.

Unlike the conventional DFE, the back-end processor BEP 600 is not limited in use of the standard controllers. This makes the control of the image forming operation by the back-end processor BEP 600 more flexible in terms of speeds and expandability than that provided by the DFE. Accordingly, it is easier to provide the image forming apparatus 1 with improved speeds and functions when compared with the conventional structural examples.

Furthermore, in the configuration according to the first embodiment, the front-end processor FEP 500 can perform the RIP processing while the back-end processor BEP 600 can carry out page reallocation to the image forming apparatus 1, and thus the DFE (more specifically, the front-end processor FEP) and the image forming apparatus 1 (more specifically, the printing engine or the fuser) can be loosely related to each other (Loose connection). That is, the front-end processor FEP and the printing engine or the like can be loosely related to each other, thereby making it possible to limit the processing of the DFE within the range, such as the RIP processing, which is not affected by the processing characteristics of the image forming apparatus 1.

This reduces the processing burden of the DFE, thereby making it possible to use a DFE comprising a general-purpose controller capable of performing high-speed processing and thus reducing total system costs. In addition to this, as shown in FIG. 3B, since a general-purpose DFE can be used, it is possible to construct a system in which one image forming apparatus 1 receives printing requests from a plurality of DFEs, i.e., a system having a ratio of the number of DFEs to that of image forming apparatuses equal to n:1.

Furthermore, as shown in FIG. 3C, it is also possible to construct a system having a plurality of image forming apparatuses 1 connected thereto, i.e., a system having a ratio of the number of DFEs to that of image forming apparatuses equal to n:m. In this case, it is possible to provide a system in which two types of image forming apparatuses 1, such as a high-speed and high-performance image forming apparatus 1 and an output check proofer (an example of the image forming apparatus 1), are disposed in parallel or alternatively in cascade for parallel processing at the stage subsequent to the back-end processor BEP.

A system with a proofer connected thereto can be used to construct a DDCP (Digital Direct Color Proofing) system in which the proofer outputs color calibration prints directly from DTP data before the high-speed and highly-functional image forming apparatus 1 performs direct printing. For example, after having received proof data as a printing job, the back-end processor BEP outputs image data to the proofer in a form suitable for proofing (e.g., in the form of low video rate) and then instructs the proofer to output the color calibration print. Meanwhile, when having received an ordinary printing job, the back-end processor BEP outputs image data having high video rates to a high-speed and highly-functional machine, issuing an instruction for high-speed and highly-functional printing.

In the case of the system shown in FIG. 3C, it is preferable to incorporate a CMS (Color Management system) for correcting for a subtle difference in output color between the high-speed and highly-functional machine and a proofer or a type of apparatus connected in cascade.

As described above, the system of n:1 or n:m makes it possible to provide efficient output processing according to the availability of the image forming apparatus 1 or by selecting an image forming apparatus suitable for the printing job.

FIG. 4 is a block diagram illustrating a second embodiment of the front-end processor FEP 500 and the back-end processor BEP 600.

This embodiment is different in configuration from the first embodiment in that this system provides appropriate processing in accordance with the characteristics of image objects such as expressed mainly in binary line work or characters (hereinafter referred to as the line work character object LW (Line Work)) or image objects such as expressed mainly in multi-tones like a background or photographic portion (hereinafter referred to as the multi-tone image object CT (Continuous Tone)).

This embodiment is also different in configuration from the first embodiment in that the back-end processor BEP 600 is provided with a tone corrective processor 640 for performing corrective processing (Tone Reproduction Correction) of tone characteristics (Tone Reproduction Curve) dependent on the characteristics of the printing engine 30 and the fuser 70.

In order to provide processing suitable for the characteristics of image objects, the front-end processor FEP 500 first comprises an image data separator 520, which separates the image data generated by the RIP processor 510, or an example of an image data generator, into line work data DLW indicative of the line work character object LW and continuous tone image data DCT indicative of the multi-tone image object CT.

In order to compress separately the line work character object LW and the multi-tone image object CT corresponding to the image data separator 520, the compressive processor 530 comprises an LW compressive processor 532 for performing compressive processing on the line work data DLW and a CT compressive processor 534 for performing compressive processing on the continuous tone image data DCT.

At the stage subsequent to the compressive processor 530, there is provided a file transfer portion 540 for packing the line work data DLWl compressed by the LW compressive processor 532 and the continuous tone image data DCT1 compressed by the CT compressive processor 534 in a print file in conjunction with a job ticket and transferring the packed file to the back-end processor BEP 600.

The file transfer portion 540 incorporates a communications interface, independent of the image recorder, for transmitting electric signals between the output side such as the IOT module 2 or the output module 7 and the back-end processor BEP 600.

On the other hand, the back-end processor BEP 600 comprises a separate data receiver 601 for receiving a print file (including the line work data DLWl, the continuous tone image data DCT1, and the job ticket) transferred from the file transfer portion 540 and storing the print file in the image storage portion 602.

The separate data receiver 601 incorporates a communications interface, independent of the image recorder, for transmitting electric signals between the output side such as the IOT module 2 or the output module 7 and the front-end processor FEP 500.

Furthermore, in order to expand the line work character object LW and the multi-tone image object CT separately corresponding to the compressive processor 530 of the front-end processor FEP 500, the expansive processor 610 of the back-end processor BEP 600 comprises an LW expansive processor 612 for performing expansive processing on the line work data DLWl compressed by the LW compressive processor 532 and the continuous tone image data DCT1 compressed by the CT compressive processor 534.

At the stage subsequent to the expansive processor 610, provided are a merging portion 630, or an example of image data coupler, for coupling the separately expanded line work data DLW and continuous tone image data DCT, and the tone corrective processor 640 for performing corrective processing (tone reproduction corrective processing) on the tone reproduction curve TRC dependent on the printing engine 30.

At the stage subsequent to the tone corrective processor 640, there is provided on the output side an interface portion 650 for transmitting electric signals with the image recorder by means of a communications interface dependent on the image recorder.

The merging portion 630 comprises an LW resolution match portion 632 and a CT resolution match portion 634 serving as a functional portion for matching the resolutions of the line work character object LW and the multi-tone image object CT. Additionally, the merging portion 630 comprises an image coupler 636 for integrating (packing) the resolution-matched line work character object LW and multi-tone image object CT into one image, and a shading processor 638 for performing shading processing on the integrated image.

The tone corrective processor 640 performs gamma (γ) correction on the digital image data of each color of YMCK, for example, with reference to a lookup table LUT. The tone corrective processor 640 performs color corrective processing in accordance with the area ratio of the characteristic values of the printing engine 30 on the color image data Y, M, C, K, each indicative of density and lightness or the internal characteristic values of the print output signal processing system. These techniques are known in the art and explanation is omitted.

The YMCK data processed by the tone corrective processor 640 are subjected to screen processing or half-toning processing (quasi-tone processing) at an intermediate processor (not shown), and then inputted to a light source (not shown) of the printing engine 30 as a modulation binary signal.

In the configuration according to the second embodiment, at the front-end processor FEP 500, the PDL data described in Page Description Language is inputted to the RIP processor 510 and then subjected to the RIP processing to be converted into raster images. Then, at the image data separator 520 in the subsequent stage, the raster image is separated into the line work data DLW and the continuous tone image data DCT.

The separated line work data DLW is sent to the LW compressive processor 532, while the continuous tone image data DCT is sent to the CT compressive processor 534, each being compressed by appropriate methods.

Methods suitable for compressing line works include G3, G4, BL (binary line art) of TIFF-IT8, and JBIG (Joint Bi-level Image Group). Methods suitable for compressing continuous tone images include PackBit of TIFF6.0 and JPEG (Joint Photographic Experts Group). Common methods for compression include SH8, Lempel-Ziv, and Huffman coding.

Methods such as G3, G4, and Huffman coding are widely used in the field of facsimile, and the Huffman coding employs variations in occurrence probability of character strings as a principal for compression.

JBIG employs a progressive build-up method by which an entire image is displayed at the initial stage of its transmission, and then additional information is provided thereto to improve the quality of the image. JBIG can be applied collectively to monochrome binary images and intermediate tone images.

BL of TIFF-IT8 codes for each line of BL data as a sequence of paired background (black) and foreground (white) runs, each line starting with a background run. The run length coding of the BL data employs two fundamental coding structures: a short format (8-bit length) for coding run lengths up to 254 pixels and a long format (24-bit length) for coding run lengths up to 65,535 pixels. The two formats can be used in combination. The individual line data begins with a byte of two zeros and ends with a byte of two zeros.

JPEG can be largely divided into a lossy irreversible compression in accordance with DCT (Discrete Cosine Transform) and a loss-less reversible compression in accordance with two-dimensional DPM (Differential Pulse Code Modulation). The DCT method is classified into a baseline method and an extended method. The baseline process is the simplest DCT method or an inevitable function of JPEG.

The line work data DLW separated as described above is compressed at the LW compressive processor 532 and then transferred to the LW expansive processor 612 on the output side (the back-end processor BEP 600), while the continuous tone image data DCT is compressed at the CT compressive processor 534 and then transferred to the CT expansive processor 614 on the output side (the back-end processor BEP 600). The expansive processors 612 and 614 expand data by the methods suitable for their respective compression methods, sending the expanded line work data DLW2 to the LW resolution match portion 632 of the merging portion 630 and the expanded continuous tone image data DCT2 to the CT resolution match portion 634 of the merging portion 630.

The LW resolution match portion 632 and the CT resolution match portion 634 match the resolutions of two image objects. For example, when the continuous tone image data DCT2 has a resolution of 400 DPI (Dots Per Inch or the number of pixels per inch) and the line work data DLW2 has a resolution of 1200 DPI, the continuous tone image data DCT2 is enlarged three times so as to match the resolutions of the two types of image objects. Both data having the same resolution (DPI) provided by the LW resolution match portions 632 and 634 is sent to an image coupler 114 and then integrated into one piece of image data D2. The integrated image data D2 is further shaded at the shading processor 638 and then inputted to the tone corrective processor 640.

As described above, according to the configuration of the second embodiment, the RIP processor 510 of the front-end processor FEP 500 transfers image data to the back-end processor BEP 600 on the output side. The image data is separated into the line work character object LW and the multi-tone image object CT and then compressed using compression methods suitable for each of them, thereby making it possible to increase the compression ratio of data.

For example, 270 MB of A2-size data is compressed into 67 BM (even in the first embodiment), and can be compressed down to 16 MB in the second embodiment. Furthermore, it takes time to perform raster image processing on PDL data, however, the PDL data could be separated according to the object attributes and then subjected individually to raster image processing (rasterized), thereby making it possible to shorten the time required for the RIP processing.

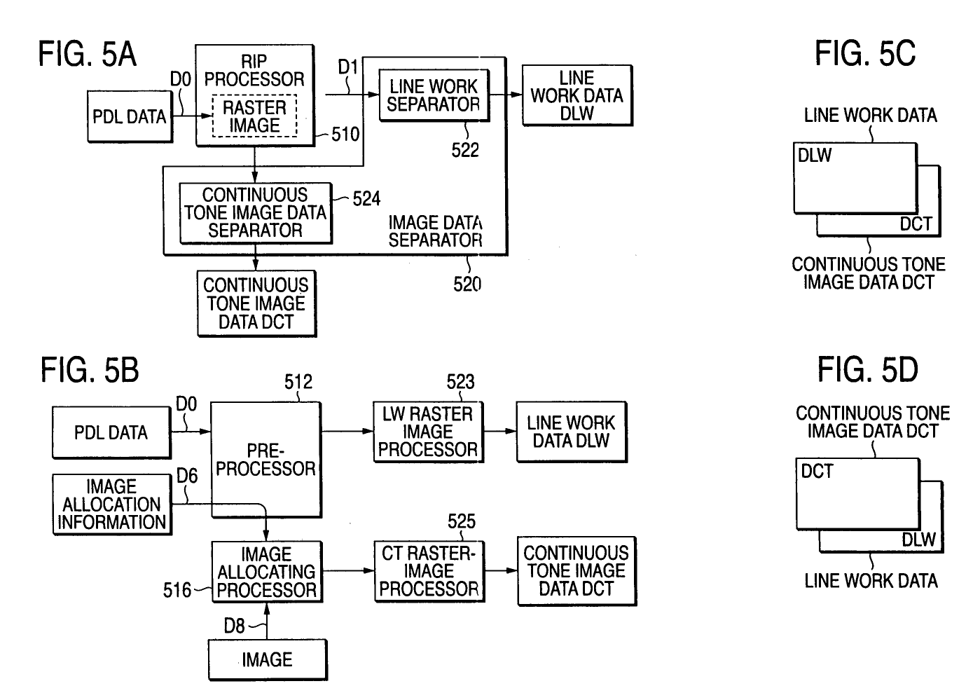

FIG. 5 is an explanatory view illustrating the separation of the line work data DLW and the continuous tone image data DCT. FIG. 5A illustrates a first method, FIG. 5B illustrating a second method. FIGS. 5C and 5D are explanatory views illustrating the degree of priority of the line work data DLW and the continuous tone image data DCT upon packing the line work data DLW and the continuous tone image data DCT into one print file.

In the first method shown in FIG. 5A, image data is extracted from PDL data (Page Description Language data) and employed as the continuous tone image data DCT, and the remaining data is employed as line work data DLW.

In the second method shown in FIG. 5B, the RIP processor 510 performs processing in cooperation with the image data separator 520. That is, the PDL data D0 is inputted to a pre-processor 512 in conjunction with image allocation information D6 as well. The pre-processor 512 rasterizes the line work object in the PDL data D0 at an LW raster image processor 523 having the RIP processing function and a function for separating the line work character object LW, and then outputs the resulting data as the line work data DLW.

Then, the image allocation information D6 passes through the pre-processor 512 without being changed and then inputted to an image allocating processor 516 while image data D8 is also inputted to the image allocating processor 516. The image allocated data is rasterized at a CT raster-image processor 525 having the RIP processing function and a function for separating the multi-tone image object CT and then outputted as the continuous tone image data DCT. Alternatively, the data is outputted as the continuous tone image data DCT without passing through the LW raster-image processor 525.

The separated two pieces of image data (the line work data DLW and the continuous tone image data DCT) are layered separately and then packed in one print file. The line work data DLW is color pallet excluding tone images or binary images, while the continuous tone image data DCT is tone data containing tone images and has a lower resolution than the line work data DLW.

However, when the line work data DLW is color pallet, it has at least white/black/transparent data as the line work data information. Thus, in this case, as shown in FIG. 5C, the line work data DLW is a priority (higher level) image. On the other hand, when the line work data DLW is binary images, it has no transparency information but the continuous tone image data DCT has transparency information. For example, the data contains 0=transparent, 1=white, . . . , and 255=black. In this case, as shown in FIG. 5D, the continuous tone image data DCT is a priority (higher level) image.

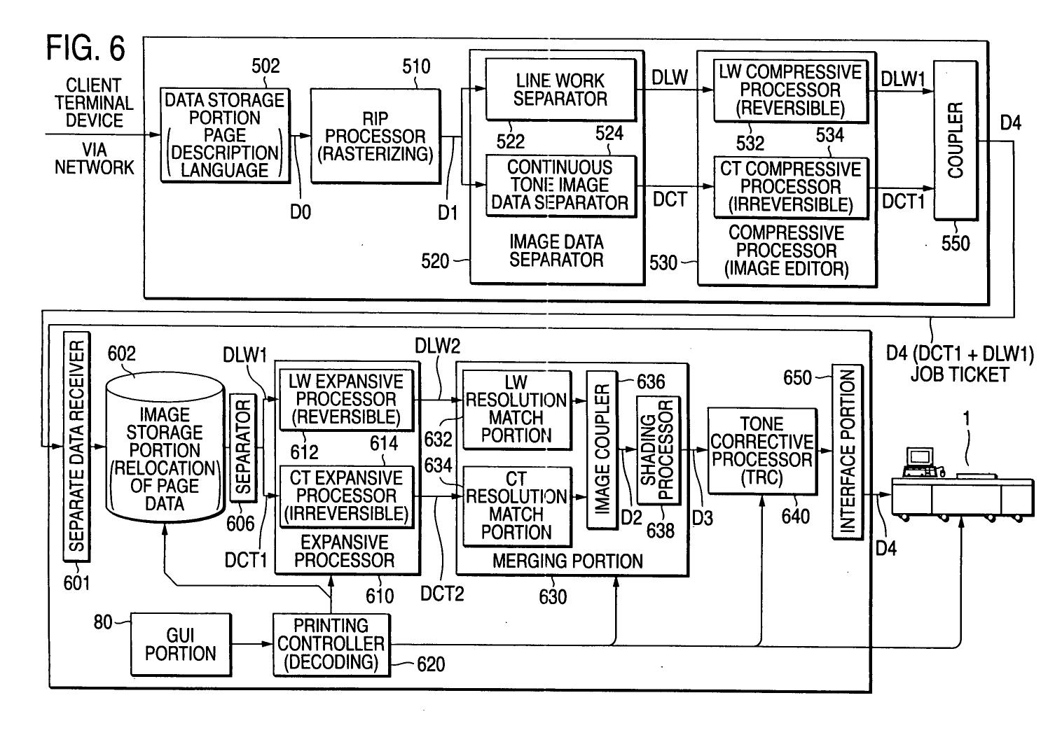

FIG. 6 is a block diagram illustrating a third embodiment of the front-end processor FEP 500 and the back-end processor BEP 600.

The configuration of the third embodiment is similar to that of the second embodiment in that processing is performed to meet the characteristics of image objects such as the line work character object LW and the multi-tone image object CT, but different in the method for integration of separated images. More specifically, in the second embodiment described above, the compressed line work data DLW1 and the continuous tone image data DCT1 are transferred to the output side (the back-end processor BEP 600) as individual data. However, in the configuration according to the third embodiment, the image data DLW, DCT, once separated, are coupled at the front-end processor FEP and then transferred to the back-end processor BEP.

For this reason, first, in place of the file transfer portion 540, the front-end processor FEP 500 comprises a coupler 550 for temporarily coupling the line work data DLWl compressed by the LW compressive processor 532 and the continuous tone image data DCT1 by the CT compressive processor 534, and then transferring the coupled one-piece image data D4 to the coupler 550.

The coupler 550 incorporates an interface portion for transmitting electric signals with the back-end processor BEP 600 by means of a communications interface independent of the image recorder such as the IOT module 2 or the output module 7 on the output side.

Corresponding to this, the back-end processor BEP 600 comprises a separator 606 for re-separating the coupled one-piece image data D4 into the line work data DLW1 and the continuous tone image data DCT1. The separated line work data DLWl and the continuous tone image data DCT2 are processed in the same manner as the second embodiment.

As described above, the second and third embodiments are described as examples in which image data is processed by being separated into the line work data DLW mainly consisting of the line work character object LW and the continuous tone image data DCT mainly consisting of the multi-tone image object CT. These configurations are the same as that of the first embodiment in that the processing on the front-end side is independent of the printing engine. The second and third embodiments can provide the same effects as can be obtained in the first embodiment.

The present invention is described with reference to the embodiments; however, the technical scope of the present invention is not limited to those of the aforementioned embodiments. A variety of changes and modifications can be made to the aforementioned embodiments without departing from the scope and spirit of the present invention, and those changes and modifications are also included in the technical scope of the present invention.

The aforementioned embodiments are not intended to limit the present invention according to the claims, and all combinations of the features described in the embodiments are not necessarily the means for solving the problems according to the present invention. The aforementioned embodiments include various steps of the invention, and it is possible to extract various types of inventions in appropriate combinations of a plurality of constituent features disclosed. Even when several constituent features are excluded from all constituent features indicated in the embodiments, the remaining constituent features can also be extracted so long as they provide inventive effects.

For example, in the aforementioned embodiments, such a case is described in which the present invention is applied to a system that employs the electro-photography process as the printing engine or the main portion for forming visible images on a recording medium. However, the applicable scope of the present invention is not limited thereto. For example, the present invention is also applicable to an image forming system comprising an image forming apparatus for forming visible images on sheets of plain paper or photosensitive paper with an engine equipped with a conventional image forming mechanism such as a heat-sensitive, thermal transfer, ink-jet mechanism, or the like.

Furthermore, in the aforementioned embodiments, such an exemplary printer is explained which comprises as an image forming apparatus a printing engine employing the electro-photography process. However, the image forming apparatus is not limited thereto, and may be any one such as a color copier or a facsimile so long as it has a so-called printing capability for forming images on the recording medium.

As described above, according to the present invention, first, the front-end processor is configured to generate image data independent of the processing characteristics of an image recorder. The back-end processor is provided with an image storage portion for receiving and storing image data processed by the front-end processor independent of the processing characteristics of the image recorder. The back-end processor is also provided with a printing controller for providing control to perform processing, dependent on the image storage portion, on image data read from the image storage portion and then send the resulting data to the image storage portion. This facilitates the development of a high-performance and highly functional system.

That is, in the conventional system configuration, one front-end processor is responsible for a RIP engine for generating image data (performing RIP processing) and a printer controller for controlling the image recorder in accordance with the processing characteristics of the image storage portion (mainly the printing engine and the fuser).

In contrast to this, the configuration according to the present invention is designed such that the system is divided into a front-end processor and a back-end processor, while the printer controller for controlling the image recorder in accordance with the processing characteristics of the image storage portion is removed from the front-end processor, so that the front-end processor can exclusively perform the RIP processing in principle. On the other hand, the printer controller removed from the front-end processor is relocated in the back-end processor that is tightly connected to the image recorder or the output side.

This allows the front-end processor and the image recorder to be loosely related to each other, thereby making it possible to construct a system in which the processing on the side of the front-end processor is not dependent on (independent of) the image recorder (such as the printing engine on the output side). That is, the front-end processor can exclusively generate images or perform compressive processing without considering the output side, while the back-end processor can exclusively perform expansive processing or the image forming operation of the printing engine without considering the image generation.

Accordingly, this allows the front-end processor to perform efficient RIP processing or compressive processing using a general-purpose RIP engine. Since the back-end processor is responsible for control in processing suitable for the devices on the output side, it is not necessary to provide each of the devices on the output side with a dedicated front-end processor. Thus, it is possible to reduce the man-hours for developing a front-end processor, and it is not necessary for the user to purchase an additional RIP engine for each type of system. Accordingly, it is easy to develop a system with high-performance and highly-functional system.

[FIG. 1A]

1: Image forming apparatus

2: IOT module

5: Feed module

7: Output module

A: RIP processing function

B: Print file

C: High-speed LAN

D: Controller function

E: I/F board

[FIG. 1B]

A: I/F board

[FIG. 2]

80: GUI portion

500: Front-end processor FEP

502: Data storage portion

510: RIP processor

530: Compressive processor

600: Back-end processor BEP

602: Image storage portion (Relocation of page data)

610: Expansive processor (Image editor)

620: Printing controller

622: Output format identification portion

624: Controller

A: Client terminal device

B: Via network

C: Input side (DEF)

D: PDL data spool

E: Processing independent of the characteristics of printing job and IOT core portion

(e.g.) processing asynchronous to engine speed

F: Output side

G: Job ticket

H: Image recorder (IOT core portion 20)

I: Processing dependent on the characteristics of printing job and IOT core portion

(e.g.) processing synchronous to engine speed

[FIG. 3A]

1: Image forming apparatus

8: User interface

A: RIP processing & controller

B: Generally dedicated

[FIG. 3B]

1: Image forming apparatus

A: High-speed LAN

B: General-purpose one

C: Print file

Number of copies

Two-sided or one-sided printing

Color or monochrome

Combined printing

With or without sorting

With or without stapler

D: Mainly RIP processing

E: System with DFEs to image forming apparatus equal to n:1

[FIG. 3C]

1: Image forming apparatus

A: High-speed LAN

B: Proofer

C: High-speed and high-performance

D: System with DFEs to image forming apparatuses equal to n:m

[FIG. 4]

1: Image forming apparatus (particularly subsequent to the IOT core portion 20)

80: GUI portion

502: Data storage portion (Page Description Language)

510: RIP processor (Rasterizing)

520: Image data separator

522: Line work separator

524: Continuous tone image data separator

530: Compressive processor (image editor)

532: LW compressive processor (reversible)

534: CT compressive processor (irreversible)

540: File transfer portion

601: Separate data receiver

602: Image storage portion (Relocation of page data)

610: Expansive processor

612: LW expansive processor (reversible)

614: CT expansive processor (irreversible)

620: Printing controller (decoding)

630: Merging portion

632: LW resolution match portion

634: CT resolution match portion

636: Image coupler

638: Shading processor

640: Tone corrective processor (TRC)

650: Interface portion

A: Client terminal device

B: Via network

C: Job ticket

[FIG. 5A]

520: Image data separator

522: Line work separator

524: Continuous tone image data separator

A: PDL data

B: RIP processor

C: Raster image

D: Continuous tone image data DCT

E: Line work data DLW

[FIG. 5B]

512: Pre-processor

516: Image allocating processor

523: LW raster image processor

525: CT raster-image processor

A: PDL data

B: Image allocation information

C: Image

D: Line work data DLW

E: Continuous tone image data DCT

[FIG. 5C]

A: Line work data

B: Continuous tone image data DCT

[FIG. 5D]

A: Continuous tone image data DCT

B: Line work data

[FIG. 6]

1: Image forming apparatus (particularly subsequent to the IOT core portion 20)

80: GUI portion

502: Data storage portion (Page Description Language)

510: RIP processor (Rasterizing)

520: Image data separator

522: Line work separator

524: Continuous tone image data separator

530: Compressive processor (image editor)

532: LW compressive processor (reversible)

534: CT compressive processor (irreversible)

550: Coupler

601: Separate data receiver

602: Image storage portion (Relocation of page data)

606: Separator

610: Expansive processor

612: LW expansive processor (reversible)

614: CT expansive processor (irreversible)

620: Printing controller (decoding)

630: Merging portion

632: LW resolution match portion

634: CT resolution match portion

636: Image coupler

638: Shading processor

640: Tone corrective processor (TRC)

650: Interface portion

A: Client terminal device

B: Via network

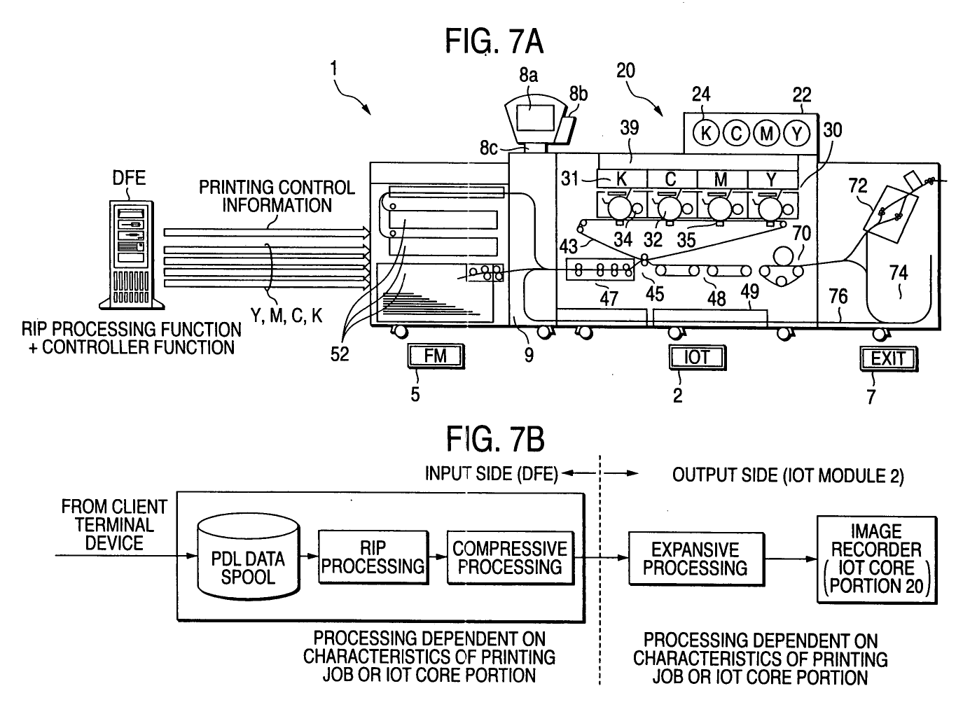

C: Job ticket

[FIG. 7A]

1: Image forming apparatus

2: IOT module

5: Feed module

7: Output module

9: Coupling module

20: IOT core portion

22: Toner supplier

30: Printing engine

52: Sheet tray

A: RIP processing function+controller function

B: Printing control information

[FIG. 7B]

A: From client terminal device

B: PDL data spool

C: RIP processing

D: Compressive processing

E: Input side (DFE)

F: Processing dependent on the characteristics of printing job or the IOT core portion

G: Output side (IOT module 2)

H: Expansive processing

I: Image recorder (IOT core portion 20)

J: Processing dependent on the characteristics of printing job or the IOT core portion

What is claimed is:

1. An image forming system comprising:
a front-end processor having an image data generator for generating image data of each page by processing a printing job, and
a back-end processor for receiving image data of each page from said front-end processor, sending the image data to an image recorder, and controlling said image recorder, wherein
said front-end processor generates the image data independent of said image recorder, and
said back-end processor includes;
an image storage portion for receiving and storing image data processed by said front-end processor independent of said image recorder, and
a printing controller for controlling to perform processing dependent on said image recorder on the image data read from said image storage portion and send the image data to said image recorder.

2. The image forming system according to claim 1, wherein
said printing controller controls each functional portion of said back-end processor to receive information related to an output format desired by a client, perform processing in accordance with the output format indicated by the received information and desired by the client, and send the image data to said image recorder.

3. An image forming system comprising:
a front-end processor having an image data generator for generating image data of each page by processing a printing job and a compressive processor for compressing image data generated by the image data generator, and
a back-end processor having an expansive processor, provided corresponding to an image recorder for recording an image on a predetermined recording medium, for expanding compressed image data of each page from said front-end processor and sending the expanded image data to said image recorder, wherein
said front-end processor generates and compresses the image data asynchronous to a processing speed of said image recorder, and
said back-end processor includes an image storage portion for receiving and storing compressed image data processed by said front-end processor asynchronous to the processing speed of said image recorder, and
said expansive processor reads the compressed image data from said image storage portion and performs expansive processing synchronous to the processing speed of said image recorder.

4. The image forming system according to claim 3, wherein
said front-end processor includes an image data separator for separating said image data into binary image data and continuous tone image data in accordance with electronic data described in a page description language,
said compressive processor performs compressive processing separately on said binary image data and continuous tone image data, separated at said image data separator, and
said back-end processor allows said expansive processor to perform expansive processing separately on the binary image data and the continuous tone image data.

5. The image forming system according to claim 4, further comprising:
an image data coupler for coupling the binary image data and the continuous tone image data which are separated by said image data separator, provided at least in one of said front-end processor and said back-end processor.

6. The image forming system according to claim 1, wherein
said front-end processor and said back-end processor transmit an electric signal therebetween via a communications interface independent of said image recorder, and
said back-end processor and said image recorder transmit an electric signal therebetween via a communications interface dependent on said image recorder.

7. A back-end processor disposed for use between a front-end processor having an image data generator for generating image data of each page by processing a printing job and an image recorder for recording an image on a predetermined recording medium, said back-end processor for receiving image data of each page from said front-end processor, sending the image data to said image recorder, and controlling said image recorder,
said back-end processor comprising:
an image storage portion for receiving and storing image data processed by said front-end processor independent of said image recorder, and
a printing controller for controlling to perform processing dependent on said image recorder on the image data read from said image storage portion and send the image data to said image recorder.

8. The back-end processor according to claim 7, wherein
said printing controller controls so as to receive information related to an output format desired by a client, perform processing in accordance with the output format indicated by the received information and desired by the client, and send the image data to said image recorder.

9. A back-end processor disposed for use between a front-end processor, having an image data generator for generating image data of each page by processing a printing job and a compressive processor for compressing image data generated by said image data generator, and an image recorder for recording an image on a predetermined recording medium,
said back-end processor comprising:
an expansive processor for expanding compressed image data of each page from said front-end processor and sending the expanded image data to said image recorder,
an image storage portion for receiving and storing compressed image data processed by said front-end processor asynchronous to a processing speed of said image recorder is included, wherein
said expansive processor reads the compressed image data from said image storage portion and performs expansive processing synchronous to the processing speed of said image recorder.

10. The back-end processor according to claim 9, further comprising:
a separated-data receiver for receiving the image data separated into a binary image portion and a continuous tone image portion, wherein
said expansive processor performs expansive processing separately on binary image data indicative of said binary image portion and continuous tone image data indicative of said continuous tone image portion.

11. The back-end processor according to claim 10, further comprising:
an image data coupler for coupling the binary image data indicative of said binary image portion and continuous tone image data indicative of said continuous tone image portion.

12. The back-end processor according to claim 7, further comprising:
a front-end side interface portion responsible for transmission of an electric signal with said front-end processor by means of a communications interface independent of said image recorder, and
an output-side interface portion responsible for transmission of an electric signal with said image recorder by means of a communications interface dependent on said image recorder.

13. The image forming system according to claim 3, wherein
said front-end processor and said back-end processor transmit an electric signal therebetween via a communications interface independent of said image recorder, and
said back-end processor and said image recorder transmit an electric signal therebetween via a communications interface dependent on said image recorder.

14. The back-end processor according to claim 9, further comprising:
a front-end side interface portion responsible for transmission of an electric signal with said front-end processor by means of a communications interface in dependent of said image recorder, and
an output-side interface portion responsible for transmission of an electric signal with said image recorder by means of a communications interface dependent on said image recorder.
